(19) United States
(12) Patent Application Publication
(10) Pub. No.: US 2026/0270492 A1
(43) Pub. Date: Sep. 10, 2026

(54) Method and System for Managing Multiple Versions of a Video Asset

(71) Applicant: AD SIGNAL LIMITED, York (GB)

(72) Inventors: Thomas Dunning, York (GB); James Hampshire, York (GB)

(21) Appl. No.: 19/166,017

(22) PCT Filed: Mar. 18, 2024
(86) PCT No.: PCT/GB2024/050729

§ 371 Date: Sep. 16, 2025

(30) Foreign Application Priority Data
Mar. 17, 2023 (GB) 2303915.9

(51) Int. Cl. H04N 21/231; H04N 21/233; H04N 21/234; H04N 21/266; H04N 21/845; H04N 21/858

(52) U.S. Cl. CPC H04N 21/23113; H04N 21/233; H04N 21/23418; H04N 21/266; H04N 21/8451; H04N 21/8586

(57) ABSTRACT

A computer-implemented method of managing multiple different versions of a video asset is provided, where each version of the video asset comprises video data including a sequence of image frames. The method comprises automatically identifying a set of one or more unique video segments from which the video data of each version of the video asset can be constructed. This involves generating, for each version of the video asset, image fingerprint information for each image frame based on its content. It further involves comparing the image fingerprint information of each version to identify one or more shared video segments that are used in at least two of the versions, and any version-specific video segments. Further, it involves determining, for each version of the video asset, a composition of one or more unique video segments from the set that makes up the video data of the respective version.

### TECHNICAL FIELD

This invention relates generally to systems and methods for managing and processing multiple versions of a digital video asset, particularly to avoid storing duplicated content.

### BACKGROUND TO THE INVENTION

Video is fast becoming the most demanding type of media content. It is estimated that by the end of 2022 over 80% of global internet traffic will be made up of video streams and downloads. As a result, aside from the ever-increasing film and programme content being produced, televised and available on streaming and video on demand (VOD) services such as Netflix and BBC iPlayer, producing engaging video content for product advertising has also become an essential marketing tool for businesses globally.

The vast amount of video content requires vast amounts of storage and effective systems and methods of video asset management. In addition, individual video assets must be tailored for global distribution in various formats and are often amended over time, which necessitates the production of multiple different versions of a video asset, e.g. for special editions/edits, alternate languages, subtitles, airline edits, territorial compliance etc. The ever-increasing number of versions produced (known in the industry as “versionitis”) places further demand on storage and distribution requirements.

Traditionally, each version is individually stored, distributed and downloaded in full, but as each version will contain a significant proportion of content in common with the other versions there is significant duplication of content. The interoperable master format (IMF) was developed to solve just this problem for business-to-business distribution of multiple versions of material. IMF is a file-based framework held up by the Society of Motion Picture and Television Engineers (SMPTE) and digital production partnership (DPP) as standard 2067-2 that allows the storage of multiple versions of a video asset with a fraction of the storage size. An IMF package contains a number of unique video and audio track files which each contain a snippet or segment of content from the versions along with any metadata (including subtitles and captions) that, when combined in various ways, create the different versions of the video asset in a “composition”. A composition playlist file (CPL) defines the composition of track files, the metadata for each version and the playback timeline for the composition. For example, instead of having a version of a TV programme in 200 languages, each version being roughly 700 GB and held in a separate master file, an IMF package containing all the video and audio components required to create the different language versions might only be 900 GB in total, saving considerable storage space.

Currently, IMF packages are created manually, or semi-automatically, whereby teams of post-production or video editing experts must manually determine which snippets or sections of video/audio to extract from each version master in order to correctly construct each version in a composition. This process is performed by skilled individuals, is time consuming and often requires the person to watch and rewatch the content of each version several times to identify the differences and extract the snippets/segments at the right positions. The manual process is time consuming and prone to errors.

Adaptive bitrate (ABR) video further aggravates the duplication of content and storage problem since it further necessitates the creation of multiple versions at different bitrates. ABR is used when a user watches streamed or VoD video and allows users to watch video content regardless of their internet bandwidth by dynamically switching between the different bitrate versions dependent upon the detected download speed. For ABR video, a video asset (which could have been created from an IMF package), is encoded into multiple bitrates and divided into small video chunks of predefined size, e.g. 2-10s. As a video player downloads the next few video chunks, it assesses the download speed and if it drops below a threshold the player will select chunks from the lower bitrate version which will download in the required time to maintain the stream. For example, this may appear to the viewer as a lower resolution/more pixelated section of the video, and once the download speed improves, a higher bitrate is selected to restore quality.

In practice, a content delivery network (CDN) is used to distribute a video asset to tens of thousands of servers across the globe so that the video is stored locally to a user. Currently, if there are similar versions of a video asset, each variant is treated as a separate asset and uploaded in full at each bitrate. Since the video assets are spread across the CDN, the duplication of ABR content is applied across every server that serves the video asset. Further, if a version needs to be amended, the only safe way to do so is to replace the entire video asset at each bitrate. However, the full original version must remain available for a period of time (to account for any users still using the original) before being deleted from the CDN, thus using additional storage space for that period. Each server in the CDN can only hold a finite volume of content depending on the hard drive size. Therefore, the more content hosted the more servers required. The more servers that are required the more carbon consumed both in terms of daily power consumption and creation of these additional servers. Therefore, reducing the volume of content has a direct impact on cost and carbon consumption.

There is therefore a need for an automated solution to managing multiple versions of a video asset for reducing storage that can be applied to solve the above problems, in particular, to automatically generate IMF from traditional versions and to reduce the volume of content stored in CDNs for ABR. Aspects and embodiments of the present invention have been devised with the foregoing in mind.

### SUMMARY OF THE INVENTION

According to a first aspect of the invention there is provided a computer-implemented method of managing multiple different versions of a video asset that includes video data. The method comprises: automatically identifying, in the multiple versions, a set of one or more unique video segments from which the video data of each version of the video asset can be constructed, assembled or stitched together; and determining, for each version of the video asset, a composition of one or more unique video segments from the set that makes up the video data of the respective version. The video data includes a time series or sequence of image frames that are to be presented over a period of time at a frame rate. The step of automatically identifying the set of unique video segments may comprise: generating, for each version of the video asset, image fingerprint information for each image frame based on its content; and comparing the image fingerprint information of each version to identify one or more shared video segments that are used in at least two of the versions (i.e. they are duplicated in the versions), and to identify any version-specific video segments (i.e. that are not duplicated).

Advantageously, the method fully automates and streamlines the process of finding the minimum set of unique video elements required to store all the data required to compose each version of the video asset, saving considerable time and resources compared to previous manual processes. The analysis of digital fingerprints allows for the comparison of video content in a consistent, systematic and reproducible way, and significantly increases the accuracy of identifying the shared and duplicated video segments in the versions. As the set of unique video segments and composition can be used to generate an IMF package for the video asset, the invention can be applied to fully automate the process of IMF generation. The method is particularly advantageous when applied to large sets of pre-existing video content, e.g. archived video assets that require de-duplication and generation of IMF packages.

Multiple versions of a video asset are defined as a group of related video assets with similar content. Their overall content is different, but they share, or have in common, a portion of their content. The content of a video asset includes video data and may optionally further include audio data and/or timed text metadata such as subtitles and/or captions. As such, where a video asset includes video data, audio data and metadata, the multiple versions may differ in their video data, audio data, or metadata, or any combination thereof provided there is some portion of shared content (video, audio and/or metadata) across the different versions. For example, where audio is present, multiple versions of a video asset may have identical audio data but different video content, or identical video content but different audio content, or a combination of different video and audio content. In this context the term “different” is used with respect to the overall content as a whole. As such, two pieces of video/audio data that are different overall may still share a portion or segment of video/audio data. The proportion of shared content across multiple video assets required for them to be considered “versions” may be a predefined minimum proportion or percentage of shared content.

A video segment is defined herein as a sequence of consecutive image frames (containing multiple image frames). The set of unique video segments is defined as a group of one or more individual video segments that do not contain any duplicated content, i.e. the content of any unique video segment is not duplicated within the set. It will be appreciated that where the video assets comprise audio and/or metadata, the video data of each version can be identical (e.g. because the versions may differ in audio), in which case the set of unique video segments may consist of a single video segment that contains all of the video data used for each version of the video asset.

The determined composition may comprise a list of unique video segments from the set that makes up the video data, along with information on the order or playback timeline required to recreate the video data of the respective version. The list may be or comprise a list of references to the unique video segments of the set, such as identifiers of the respective unique video segments. For example, the list may reference a stored location of the set from which the unique video segments can be retrieved.

The method may further comprise receiving a plurality of video assets including the multiple different versions of a video asset. The plurality of video assets may consist of the multiple versions of the video asset, or the plurality of video assets may include the multiple versions of the video asset and additional video assets.

Comparing the image fingerprint information of each version may comprise: selecting one of the versions as a base version; and comparing the image fingerprint information of the base version to the fingerprint information of each other version frame-by-frame to identify one or more sequences of matching image frames indicative of one or more shared video segments, and to identify any sequences of unique image frames that are indicative of version-specific video segments. Preferably, the image fingerprint information is compared by timecode.

Comparing the image fingerprint information of a given pair of image frames may comprise: computing one or more similarity or distance metrics from the image fingerprint information of the pair of image frames; and identifying the pair of image frames as matching if the one or more similarity or distance metrics satisfy one or more respective matching conditions.

Image fingerprint information means information/data representing the visual content of a digital image, which may be obtained using any suitable technique that produces similar fingerprints for similar image content. The fingerprint information may comprise a single piece of information/data obtained using a particular technique, or multiple pieces of information/data obtained using different respective techniques. As such, the image fingerprint information may comprise one or multiple image fingerprints.

The image fingerprint information may comprise a primary image fingerprint generated using a first image fingerprinting technique and a secondary image fingerprint generated using a second fingerprinting technique. Preferably, the primary fingerprint is generated using a perceptual Hash function, and the secondary fingerprint is generated from pixel colour information in the image frame. For example, the secondary fingerprint information may comprise a colour histogram with a plurality of colour bins, or a fingerprint derived from the colour histogram.

Generating the secondary image fingerprint may comprise extracting the colour of each pixel in the image, either as: a Red, Green, Blue (RGB); a hexadecimal colour (Hex); Hue, Saturation, Lightness (HSL); Hue Saturation, Value (HSV); or any other colour representation value. These colour values for an image can be compared in a number of ways, including: generating a colour histogram (binned or un-binned); comparing the pixel colours of two images pixel-by-pixel based on their positions (i.e. effectively overlaying the two images and determining what the colour difference is per pixel or generating a difference image); or feature extraction. These techniques can each be used in different situations to provide searchability/matchability (less granular, e.g. binned colour histogram) or accurate compatibility (more granular, e.g. un-binned colour histogram or the pixel by pixel comparison).

In this case, the identifying step may involve comparing respective sequences of the first and second fingerprints in each version, and the detecting step may comprise comparing respective first and second fingerprints in each video asset. Comparing the image fingerprint information of a given pair of image frames may then comprise: computing a first distance or similarity metric for the primary image fingerprints of the pair of image frames; computing a second distance or similarity metric from the secondary image fingerprints of the pair of image frames; and identifying the pair of image frames as matching if both the primary and secondary fingerprints satisfy a respective matching condition.

As each of the first and second fingerprints are based on different pixel information in the respective image frame, analysing two different types of fingerprints for each image frame may improve the accuracy of the identification and detection processes and reduce false positive match results.

Each unique video segment has a start timecode and end timecode. The end of one unique video segment and the start of the next consecutive unique video segment in a version timeline defines a transition point or seam between the two consecutive unique video segments in the version of the video asset when constructed according to the respective composition.

Where the fingerprint is a number string, or binary number string, or bitmask (e.g. as generated by a Hash function), the computed numerical distance/similarity value/metric may be or comprise the Hamming distance or normalised Hamming distance between the respective fingerprints. Alternatively, the bit error rate, Euclidean distance, or peak or cross-correlation can be used.

Where a fingerprint is or comprises a colour histogram, the computed numerical distance/similarity value/metric may be or comprise a percentage shift in the colour bin values (e.g. relative to the total pixel count), or the size of the colour shift per colour bin, or the size of the colour shift per pixel (e.g. the change in the R, G, B values as vectors).

The multiple versions of the video asset may further comprise audio data. In this case, the method may further comprise: automatically identifying a set of one or more unique audio segments from which the audio data of each version of the video asset can be constructed; and determining, for each version of the video asset, a composition of one or more unique audio segments from the set that makes up the audio data of the respective version. Automatically identifying the set of one or more unique audio segments may comprise: partitioning the audio data of each version into a sequence of audio slices of equal time duration; generating, for each version, an audio fingerprint for each audio slice based on its content; and comparing the audio fingerprints of each version to identify one or more shared audio segments that are used in two or more of the versions and any version-specific audio segments.

An audio segment comprises a time sequence of consecutive audio slices. The set of unique audio segments is defined as a group of one or more individual audio segments that do not contain any duplicated content, or whose content is not duplicated within the set. It will be appreciated that where the video assets comprise audio and optionally metadata the audio data of each version can be identical (because the versions may differ in video), in which case the set of unique audio segments may consist of a single audio segment that contains the audio data for each version of the video asset.

The determined composition may comprise a list of the unique audio segments from the set that makes up the audio data and information on the order or playback timeline required to create the audio data of the respective version. The list may be or comprise a list of references to the unique audio segments of the set, such as identifiers of the respective unique audio segments. The list may reference a stored location of the set from which the unique audio segments can be retrieved.

Each audio slice may temporally overlap with an adjacent audio slice in the sequence of audio slices. The overlap may be up to 25%, 50% or 75% of the duration of the audio slice, or between 25% and 75% of the duration of the audio slice, or approximately 50% of the duration of the audio slice.

Generating an audio fingerprint for each audio slice may comprise: transforming the audio slice from the time domain to the frequency domain to obtain an amplitude spectrum having a plurality of frequency components, each frequency component having a respective amplitude value; and determining an audio fingerprint based on the sequence of frequency components. Preferably, this comprises grouping the frequency components into a predefined number of bins, wherein each bin has an aggregated amplitude value; and determining an audio fingerprint based on the sequence of aggregated amplitude values associated with the bins. Optionally, the audio data in each audio slice of the version is normalised to have the same perceived loudness before transforming the audio slice to the frequency domain.

Transforming the audio slice from the time domain to the frequency domain may comprise using a Fourier transform, such as a Fast Fourier Transform (FFT). Determining an audio fingerprint based on the sequence of (binned or un-binned) amplitude values may comprise: transforming the sequence of amplitude values into a sequence of bits (i.e. 0s and 1s). Optionally or preferably, transforming the sequence of (binned or un-binned) amplitude values into a sequence of bits may comprise normalising the sequence of amplitude values, and applying a threshold. Each amplitude value in each slice may be normalised to a common reference value. The common reference value may be determined from the amplitudes of each audio slice, e.g. the largest root mean square (RMS) value in the slices, or it may be a fixed value. Alternatively or additionally, the sound signal in each audio slice may be normalised to have the same loudness unit full scale (LUFS) level, before the audio slice is transformed from the time domain to the frequency domain.

Each unique audio segment has a start timecode and end timecode. The end of one unique audio segment and the start of the next consecutive unique audio segment in a version defines a transition point between the two consecutive unique audio segments in the version of the video asset when constructed according to the respective composition.

The method may further comprise adjusting the start and/or end timecode of the unique audio segments to optimise the transition point between two consecutive unique video segments. The method may comprise: adjusting the transition point between two consecutive unique audio segments to avoid one or more of: sound above a predefined level, music and/or human speech, based on the audio content at or near the transition point. Such points of important audio could be distorted or result in artefacts if the audio is split during it.

Adjusting the transition point between the two consecutive unique audio segments may comprise: detecting the presence or absence of human speech and/or music (or specific frequencies or frequency bands associated therewith) in each audio slice of the consecutive unique audio segments based on the frequency content of the respective audio slice; and adjusting the transition point to the timecode of the nearest audio slice in which human speech and/or music is not detected.

Adjusting the transition point between the two consecutive unique audio segments may comprise: determining at least one sound level for each audio slice of the consecutive unique audio segments; and where the at least one sound level at the transition point is greater than a respective threshold value, adjusting the transition point to the timecode of the nearest audio slice in which the at least one sound level is less than the respective threshold value.

The at least one sound level may include an overall sound level of the audio slice, e.g. an average, or root mean squared (RMS) or loudness unit full scale (LUFS) level.

The at least one sound level may include one or more component sound levels for specific frequency components or bands of interest extracted from the amplitude spectrum of the audio slice. Optionally or preferably, wherein the specific frequency components or bands of interest are associated with human speech and/or music.

The method may further comprise extracting the identified set of unique video segments from the video data of the multiple versions of the video asset; and storing the extracted set of unique video segments together with version information containing the composition for each version.

The method may further comprise extracting the identified set of unique audio segments from the audio data of the multiple versions of the video asset; and storing the extracted set of unique audio segments together with version information containing the composition for each version.

The method may further comprise generating an interoperable master format (IMF) package for the multiple versions of the video asset based on the extracted set of unique video, and optionally set of unique audio segments, and the compositions of each version.

The method may comprise validating the generated IMF package. This may comprise: generating each of the multiple versions from the IMF package, each generated version comprising generated video and audio data comprising an aggregation of respective unique video and audio segments from the sets; generating, for the generated video data of each generated version of the video asset, image fingerprint information for each image frame based on its content; partitioning the generated audio data of each generated version into a sequence of audio slices of equal time duration, and generating audio fingerprint information for each audio slice of each generated version based on its content; and comparing, by timecode, the image and audio fingerprint information of each generated version to the image and audio fingerprint information of each respective version master used to generate the IMF package, to determine whether they match or not. The IMF package may then be validated if the generated image and audio data of the generated versions match the video and audio data of the respective version masters used to generate the IMF package.

The method may further comprise encoding the set of unique video segments into multiple bitrates and storing the extracted set of unique video segments at each bitrate together with version information containing the available bitrates and the composition of unique video segments for each version. Where audio data is present, the method may further comprise encoding the set of unique audio segments into the multiple bitrates, and storing the extracted set of unique audio segments at each bitrate together with version information containing the available bitrates and the composition of unique audio segments for each version. Encoding may occur before or after extracting the set of unique video/audio segments from the video/audio data of the multiple versions of the video asset.

Storing the set of unique video segments (and where present, unique audio segments) at each bitrate may comprise uploading the set of unique video (and, where present, audio) segments at each bitrate to one or more servers together with the version information for use in adaptive bitrate (ABR) streaming.

Where used in ABR streaming, the method may further comprise generating or amending, for each version, a playback control file for an ABR streaming protocol based on the version information so as to reference the unique video segments at each bitrate stored in the one or more servers; and uploading the generated or amended playback control files to the one or more servers for use in ABR streaming. The one or more servers may be or comprise a content delivery network. The version information or references may contain a list of URLs for retrieving the unique video segments from the one or more servers during playback of the video asset.

The method may further comprise receiving a new version of the video asset, the new version comprising video data including a sequence of image frames. In this case, the method may comprise automatically identifying an updated set of unique video segments from which the video data of each version of the video asset including the new version can be constructed, assembled or stitched together; and determining, for each version of the video asset, a composition of unique video segments from the updated set that makes up the video data of the respective version.

Automatically identifying an updated set of unique video segments may comprise: generating, for the new version, image fingerprint information for each image frame based on its content; and comparing the image fingerprint information of the new version to each other version, or comparing the image fingerprint information of each version, to identify one or more shared video segments that are used in at least two of the versions, and any version-specific video segments.

Identifying an updated set of one or more unique video segments from which the video data of each version of the video asset can be constructed may comprise comparing frame-by-frame the image fingerprints of each version to identify one or more sequences of matching image frames indicative one or more shared video segments, and to identify any sequences of unique image frames that are indicative version-specific video segments.

The new version of the video asset may further comprise audio data. In this case, the method may further comprise automatically identifying an updated set of one or more unique audio segments from which the audio data of all the versions of the video asset can be constructed, and determining, for each version of the video asset, an updated composition of one or more unique audio segments from the updated set that makes up the audio data of the respective version. Automatically identifying an updated set of one or more unique audio segments may comprise partitioning the audio data of the new version into a sequence of audio slices of equal time duration, and generating audio fingerprint information for each audio slice based on its content; and comparing the audio fingerprint information of each version to identify one or more shared audio segments that are used in two or more of the versions and any version-specific audio segments.

Identifying an updated set of one or more unique audio segments from which the audio data of each version of the video asset can be constructed may comprise comparing slice-by-slice the audio fingerprints of each version to identify one or more sequences of matching audio slices indicative one or more shared audio segments, and to identify any sequences of unique audio slices that are indicative version-specific audio segments.

The method may further comprise extracting the updated set of unique audio segments from the versions; and updating the stored set and the version information to include the updated set of unique audio segments, or storing the updated set of unique audio segments together with version information containing the updated composition for each version.

The method may further comprise extracting the updated set of unique video segments from the versions; and updating the stored set and the version information to include the updated set of unique video segments, or storing the updated set of unique video segments together with version information containing the updated composition for each version.

The method may further comprise updating the IMF package for the multiple versions of the video asset to include the new version, based on the updated set of unique video and audio segments and the updated compositions of each version.

Each identified unique video segment in the set may have an arbitrary size governed by the fingerprint comparison process. However, ABR streaming may require video content to be stored and made available as video chunks of a predefined size or duration. The predefined duration of the video chunks is typically defined by the particular ABR protocol. As such, alternatively, each identified unique video segment in the set can be a video chunk of a predefined size or duration, or an integer number of video chunks of a predefined size/duration. Alternatively, where the identified unique video segments in the set have an arbitrary size governed by the fingerprint comparison process, the method may further comprise: adjusting the transition points between consecutive unique video segments such that each identified unique video segment in the set correspond to an integer number of video chunks of a predefined duration.

The method may further comprise dividing any unique video segments corresponding to multiple video chunks into individual video chunks.

Where the method comprises receiving a plurality of video assets including the multiple different versions of a video asset as well as additional video assets, the method may further comprise detecting the multiple versions of the video asset in the received video assets based at least in part on comparing the video content of the video assets. Detecting multiple versions of the video asset in the received video assets may comprise: generating, for each video asset received, image fingerprint information for each image frame based on its contents; and, where the video assets comprise audio data, partitioning the audio data of each video asset into a sequence of audio slices of equal time duration, and generating, for each video asset, an audio fingerprint for each audio slice based on its content; and detecting the multiple versions of the video asset in the plurality of video assets based on a comparison of the image fingerprint information, and where present the audio fingerprint information, of each video asset.

The image fingerprint information for each image frame, and where present the audio fingerprint for each audio slice, is associated with a respective timecode. This combined information may be referred to as a fingerprint-timecode pair or coordinate.

Detecting the multiple versions may comprise: identifying a subset of candidate video assets having a predefined proportion of identical or similar image fingerprint-timecode pairs, and where present audio fingerprint-timecode pairs. Detecting the multiple versions may further comprise comparing the image fingerprint information of the identified candidate video assets frame-by-frame and by timecode, and where present the audio fingerprint information of the identified candidate video assets slice-by-slice and by timecode. Those candidate video assets having a predefined proportion of matching video and/or audio are identified as multiple similar versions of a video asset.

Those candidate video assets with identical or fully matching video content, and where present identical or fully matching audio content, may be identified as duplicate versions. Preferably, duplicate versions are then deleted.

Comparing image/audio fingerprint information or image/audio fingerprint-timecode pairs preferably comprises computing, for each pair of compared image frames, and where present each pair of compared audio slices, one or more similarity or distance metrics from the respective image and audio fingerprint information.

Identifying a subset of candidate video assets with a predefined proportion of identical or similar fingerprint-timecode pairs may comprise: comparing each image/audio fingerprint-timecode pair of a video asset to the fingerprint-timecode pairs of all the other video assets; computing, for each pair of compared image fingerprint-timecode pairs, and where present each pair of compared audio fingerprint-timecode pairs, one or more similarity or distance metrics from the respective image and audio fingerprint information; and comparing one or more similarity or distance metrics to one or more respective first threshold values. Those video assets having a predefined proportion of fingerprint-timecode pairs within the respective one or more first threshold values of each other are identified as candidate video assets.

Identifying those candidate video assets having a predefined proportion of matching video and/or audio content may comprise comparing the one or more similarity or distance metrics to one or more respective second threshold values. Where the metrics are distance metrics, the second threshold value is less than the first threshold value, and where the metrics are similarity metrics, the second threshold value is greater than the first threshold value.

Identifying duplicate video assets may comprise comparing the one or more similarity or distance metrics to one or more respective third threshold values. Where the metrics are distance metrics, the third threshold value is less than the first and second threshold value, and where the metrics are similarity metrics, the third threshold value is greater than the first and second threshold value.

Advantageously, this allows the method to automatically detect all versions of a video asset contained in the ingested video assets, which can then be analysed to identify the set of unique video segments as described above. This further streamlines the process of de-duplication, particularly when processing large sets of pre-existing, e.g. archived, video assets with an unknown number of versions.

The method described above is preferably fully automated.

According to a second aspect of the invention, there is provided a system for managing multiple different versions of a video asset. The system comprises one or more processing devices configured with instructions that, when executed by the one or more processing devices, cause the one or more processing devices to perform the method of the first aspect.

According to a third aspect of the invention, there is provided a computer-readable medium storing instructions that, when executed by one or more processing devices, cause the one or more processing devices to perform the method of the first aspect.

Features which are described in the context of separate aspects and embodiments of the invention may be used together and/or be interchangeable. Similarly, where features are, for brevity, described in the context of a single embodiment, these may also be provided separately or in any suitable sub-combination. Features described in connection with the device may have corresponding features definable with respect to the method(s), and vice versa, and these embodiments are specifically envisaged.

### BRIEF DESCRIPTION OF DRAWINGS

In order that the invention can be well understood, embodiments will now be discussed by way of example only with reference to the accompanying drawings, in which:

FIG. 1 shows a schematic diagram of a video asset;

FIGS. 2, 3, 4(a) and 4(b) show schematic diagrams of versions of a video asset with differing video content;

FIG. 5 shows a method of managing and reducing the storage size of multiple versions of a video asset according to the invention;

FIG. 6 shows a schematic diagram of video data;

FIG. 7 shows a schematic diagram of an audio slice;

FIG. 8(a) shows an example binned amplitude spectrum derived from an audio slice;

FIG. 8(b) shows an example normalised amplitude spectrum derived from the spectrum of FIG. 8(a);

FIG. 9 illustrates an example transition point adjustment;

FIG. 10 shows a schematic diagram of an interoperable master format (IMF) package;

FIG. 11 illustrates multiple bitrate versions of a video asset used in adaptive bitrate (ABR) streaming;

FIG. 12 shows example method steps for the ABR output of the method of FIG. 5;

FIG. 13 illustrates the deduplication of content for ABR streaming of different versions of a video asset resulting from the steps of FIG. 12;

FIG. 14 shows example method steps for detecting versions of a video asset in a larger set of video assets; and

FIG. 15 shows a schematic diagram of a system for managing and reducing the storage size of multiple versions of a video asset.

It should be noted that the figures are diagrammatic and may not be drawn to scale.

### DETAILED DESCRIPTION

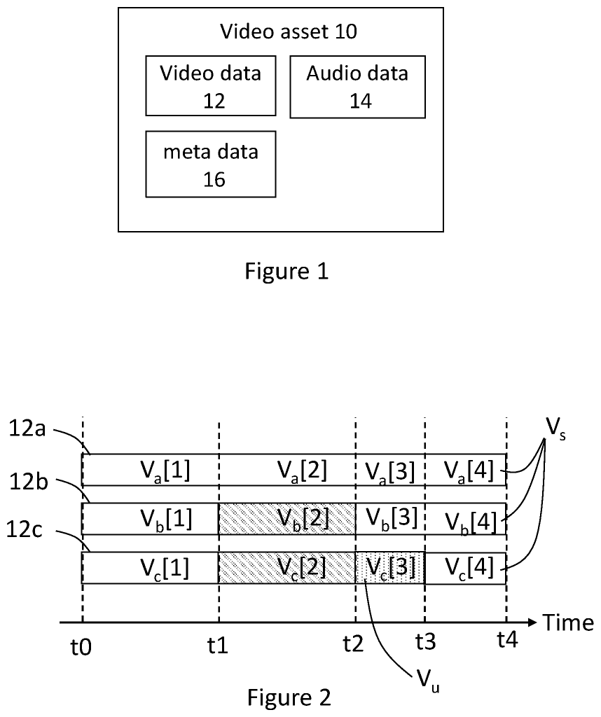

FIG. 1 shows a schematic block diagram of a video asset 10. A video asset 10 comprises video content of value to an organisation and which is distributed between businesses, such as a theatrical film, television programme, trailer, promotion, advertisement etc. A video asset 10 comprises video data 12 defining the video content of the video asset 10, and may also comprise audio data 14 (e.g. accompanying vocals and music) and/or timed text metadata 16 such as subtitles and captions for presentation with the video data 12. A video asset 10 can come in various different formats including e.g. MP4, MOV, and AVI. MP4 is the most common format for sharing videos online. MOV files are typically higher quality and necessary for showing on large screens. AVI files are multi-media, containing both audio and video content.

Multiple different versions of a video asset 10 will typically exist which have similar but not identical content, e.g. for special editions/edits, alternate languages, subtitles, airline edits, territorial compliance etc. The versions of a video asset 10 may differ in the video data 12, audio data 14 and/or metadata 16. The different versions of a video asset 10 will always have a certain amount of shared content which is common to at least two versions, and, depending on how content is varied across the versions, may also have a certain amount of version-specific content which is unique to the specific version.

By way of example, FIG. 2 shows a schematic representation of different versions of video data 12a-12c in three versions 10a-10c of a video asset 10. The video asset 10 may or may not further include audio 14 and metadata 16 (not shown). As such, the video data 12a-12c of each version 10a-10c can be divided up into a number n of video segments V[1]-V[n] that each span a period of time defined by a start and end timecode (indicated by the vertical dashed lines), and that, when combined in the correct order, make up the complete video data 12a-12c of the respective version 10a-10c. In FIG. 2, four video segments V[1]-V[4] are defined. Video segments Vₐ[1], V_{b}[1] and V_{c}[1] are identical across the different versions of video data 12a-12c, as are video segments Vₐ[4], V_{b}[4] and V_{c}[4], as indicated by the matching fill pattern. However, video segments V_{b}[2] and V_{c}[3] differ in content from their corresponding video segments Vₐ[2] and Vₐ[3] in version 12a, as indicated by the differing fill patterns. Meanwhile, video segment V_{c}[2] in video data 12c is also different to the corresponding video segment Vₐ[1] in video data 12a, but is identical to the corresponding video segment V_{b}[2] in video data 12b as indicated by the matching fill pattern. As such, in this example the multiple versions of video data 12a-12c contain a number of video segments that are duplicated and used in or are common to at least two versions, which are referred to herein as shared video segments (i.e. Vₐ[1]=V_{b}[1]=V_{c}[1], V_{b}[2]=V_{c}[2], Vₐ[3]=V_{b}[3] and Vₐ[4]=V_{b}[4]=V_{c}[4]) and also a number of version-specific video segments that are specific to a particular version (e.g. video segments Vₐ[2] and V_{c}[3]). Any audio data 14 and time-text metadata 16 of the different versions 10a-10c can be analysed in the same way (not shown).

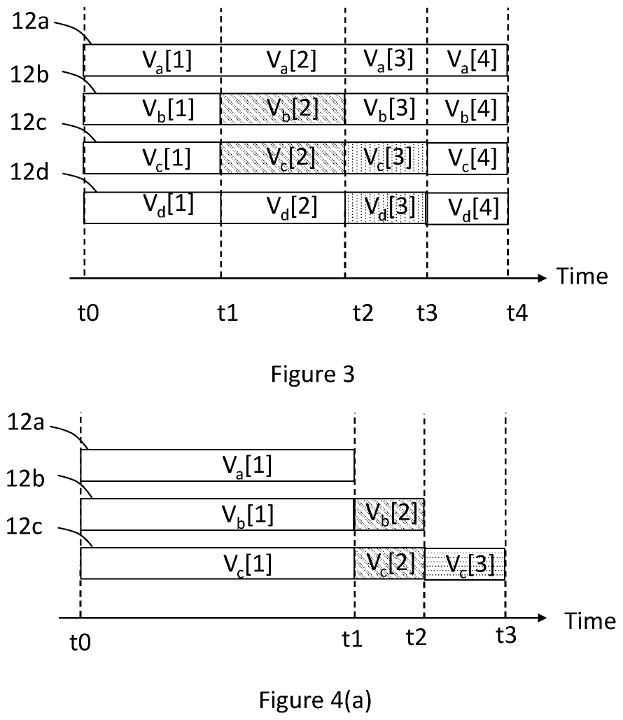

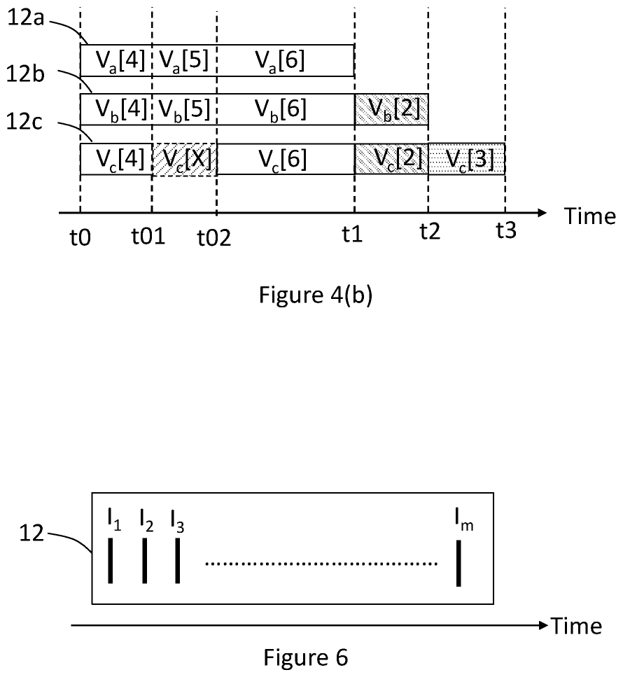

The amount of shared and version-specific content (video 12, audio 14 and/or metadata 16) will depend on how the video asset 10 is altered across the different versions. FIG. 3 shows an example of multiple versions of video data 12a-12d which contain only shared video content (i.e. no version-specific segments). Alternatively, the video content 12 of multiple versions of a video asset 10 may be identical in examples where the video asset 10 comprises audio data 14 and/or timed-text metadata 16 which differs between the versions. Further, although FIGS. 2 and 3 show the different versions of video data 12 having the same overall duration, this may not always be the case. FIG. 4(a) shows an example of multiple versions of video data 12a-12c which differ in duration as a result of new video segments being added. In the illustrated examples of FIGS. 2 to 4(a), version 10a is the base or reference version to which the content of other related versions are compared, however it will be appreciated that the choice of base version is not important.

In practice, the number of different versions of a video asset 10 can reach hundreds or even thousands. The video data 12 and audio data 14 file sizes of an individual video asset 10 can be large, e.g. video data is typically on the order of GBs and audio data is on the order of MBs. As such, storing multiple versions in full requires large storage size and results in significant duplication of content.

Instead, multiple versions of a video asset 10 can be stored with a fraction of the size by identifying and storing only a set Qᵥ of unique video segments Uᵥ, and where audio data 14 is present a set Qₐ of unique audio segments Uₐ, from which the video data 12 (and audio data 14) of all the different versions 10a-10c can be constructed. In this context, unique video/audio segments Uᵥ, Uₐ are segments with content that is not duplicated within the respective set Qᵥ, Qₐ and consist of one or more shared video/audio segments Vₛ/Aₛ and any version-specific video/audio segments Vᵤ/Aᵤ, as described above. Shared video/audio segments Vₛ/Aₛ in the set Qᵥ, Qₐ are used for multiple versions. For example, with reference to FIG. 2, the set Qᵥ of unique video segments is Qᵥ={Vₐ[1], Vₐ[2], Vₐ[3], Vₐ[4], V_{b}[2], V_{c}[3]} (noting that Vₐ[1]=V_{b}[1]=V_{c}[1] and only one of these shared segments is required in the set Qᵥ, etc.). The video data 12 and audio data 14 of the versions 10a-10c can then be constructed from the sets Qᵥ, Qₐ with knowledge of the composition of unique segments Uᵥ, Uₐ and the playback timeline for each version. This approach avoids storing duplicated content and is adopted in the interoperable master format (IMF), which is now the standard format in the industry for delivery and storage of multiple versions of video assets 10 (de-duplication of any timed-text metadata 16 is not required due to its relatively small file size). However, the core step of analysing and identifying the shared/duplicated and version-specific content has to-date been a manual and time-consuming process.

FIG. 5 shows a computer-implemented method 100 of managing and reducing the storage size of multiple versions 10a-10c of a video asset 10 according to an embodiment of the invention. The video assets 10a-10c comprise video data 12 and may further comprise audio data 14 and metadata 16. The method 100 is based on applying digital fingerprinting techniques to compare the video and audio content of video assets 10 in a quantitative, consistent and accurate manner. The method 100 fully automates the process of detecting and deduplicating video 12 and audio 14 content of video assets 10a-10c.

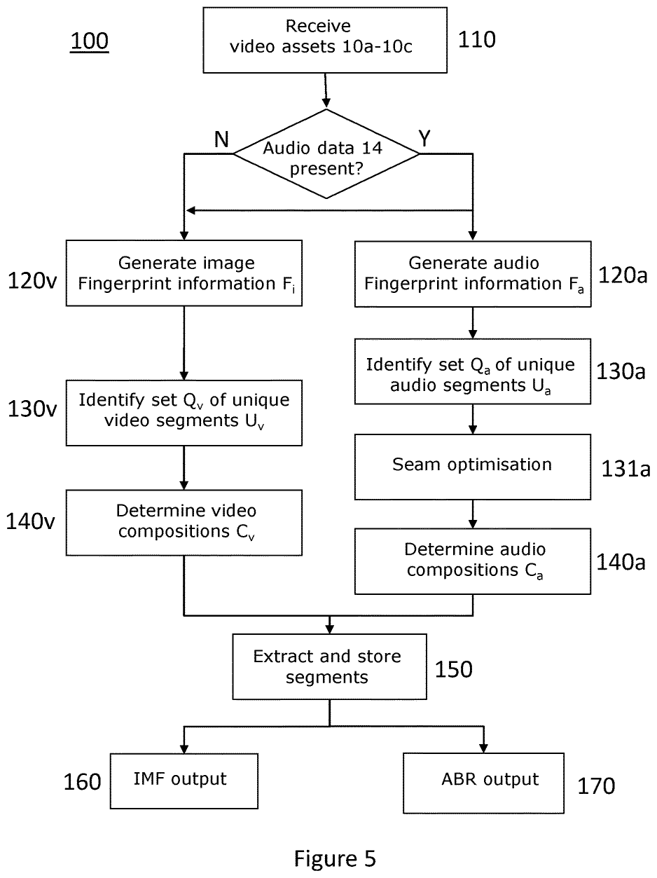

In step 110, multiple versions of a video asset 10a-10c are received. It is not important when the video assets 10a-10c are received. Related video assets 10a-10c (i.e. the versions) can be received together, or some time apart. The video data 12 of each video asset 10 comprises a sequence of image frames I₁-Iₘ that are presented over time at a given frame rate (e.g. 25 frames per second), as is known in the art and shown schematically in FIG. 6. Each image frame I₁-Iₘ has a timecode that indicates its time position in the sequence and may also include a frame number to identify the respective frame I₁-Iₘ.

In step 120v, image fingerprint information Fᵢ is generated for each image frame I₁-Iₘ of each version 10a-10c based on the content of the respective image frames I₁-Iₘ. The image fingerprint information Fᵢ is associated with the timecode of the respective image frame I₁-Iₘ (e.g. it can be tagged or paired with the timecode). Image fingerprint information Fᵢ is used herein to mean a set of one or more separate fingerprints Fᵢ₁, Fᵢ₂ containing information or data representing the visual content of the respective image frame I₁-Iₘ that are obtained using one or more respective fingerprinting techniques.

The image fingerprint information Fᵢ comprises a primary image fingerprint Fᵢ₁ generated using a perceptual Hash function. Perceptual Hash functions are algorithms that generate content-based image Hashes that do not change much when an image undergoes minor modifications (such as compression, colour-correction and brightness), as is known in the art. Numerous suitable perceptual Hash functions are available from open sources, e.g. pHash.org. The resulting image Hash Fᵢ₁ is a sequence of numbers of a certain length which can be an integer decimal number (e.g. 123) or its binary representation (e.g. 1111011). The image Hash Fᵢ₁ enables the content of any two image frames I₁-Iₘ to be readily compared using conventional similarity/distance metrics, as described in step 130v below.

Different image fingerprinting techniques are sensitive to different features of the image content. It is possible that a particular fingerprinting technique, such as perceptual Hash functions, can yield the same or near-same image fingerprint for two image frames that have obviously differing content, a problem known in the art as “collision” which produces a false positive comparison result. Collisions can be reduced by increasing the length of the fingerprint, but at the cost of increased complexity of comparison and number of redundant bits. Accordingly, in some embodiments of the method 100, additional (secondary) image fingerprints Fᵢ₂ are obtained using different fingerprinting techniques to enrich the image fingerprint information Fᵢ and reduce the possibility of fingerprint collisions.

In an example implementation, the image fingerprint information Fᵢ further comprises a secondary image fingerprint Fᵢ₂ generated from the pixel colour information of the respective image frame I₁-Iₘ. The pixel colour information in an image frame I₁-Iₘ can be used to compare image content in a number of ways. In a preferred example, a colour histogram is used as a secondary image fingerprint Fᵢ₂. A colour histogram is generated by extracting the colour of each pixel in the image frame I₁-Iₘ, either as a red, green, blue (RGB), a hexadecimal colour (Hex), or any other colour representation value, and counting the number of pixels having a given colour, or a colour within a given colour bin or range, in the colour space. For example, RGB has 256 intensity values in each of the R, G, B channels which can be divided into a number of bins. Taking four bins of equal width as an example, bin 1 corresponds to values 0-63, bin 2 corresponds to values 64-127, bin 3 corresponds to values 128-191, and bin 4 corresponds to values 192-256. The binned colour histograms of each image frame I₁-Iₘ can then be used as image fingerprints Fᵢ₂ which are compared to look for identical or altered colour distributions. Grouping into colour bins reduces the sensitivity of the resulting image fingerprint Fᵢ₂ to small changes in the image colour content, making it suitable for perceptual content comparison. The number of bins determines the granularity of the comparison (effectively the length of the fingerprint Fᵢ₂). If more detailed content comparison is required, the number of bins can be increased, or the un-binned colour histogram can be used as an image fingerprint Fᵢ₂. As an alternative to colour histograms, a precise comparison can be achieved by comparing, on a pixel-by-pixel basis, the pixel colours of two image frames based on the pixel positions or coordinates in the image frames (assuming each image frame being compared has the same size and pixel resolution).

Once the image frames I₁-Iₘ have been fingerprinted, the video data 12 of a video asset 10 can be quantitatively compared against the video data 12 of any other video asset 10 on a frame-by-frame basis.

In step 130v, a set Qᵥ of unique video segments Uᵥ is identified from which the video data 12a-12c of each version of the video asset 10 can be constructed. In this step, one of the versions is selected as a base version, and the image fingerprint information Fᵢ of the other related versions are compared frame-by-frame to the image fingerprint information Fᵢ of the base version to identify sequences of matching image frames indicative of a shared video segment Vₛ, and any sequences of unique image frames indicative of version-specific video segments Vᵤ. In this way, the method looks for matching patterns or sequences of fingerprints in the different versions to identify common video segments. In one example implementation, starting with the first image frame of the base version, its fingerprint information Fᵢ is compared to the fingerprint information Fᵢ of each of the related versions to find a matching image frame. If a match is found in any of the related versions, the respective image frame of the base version is a shared image, otherwise it is a unique image frame. The frame-by-frame comparison process then moves on to the next (by timecode) image frame of the base version, and so on. The first (by timecode) matching image frames found defines the start of a sequence of matching image frames (a shared video segment) in the respective versions, which continues until the images frames no longer match or the video data ends. Matching image frame sequences found in the versions may or may not have the same timecodes, depending on how the versions were varied. For example, if new content is inserted at the beginning or the middle of a version, matching image frame sequences may have shifted timecodes (e.g., the matching sequence may start at 3s in one version and 54s in another version). Only one of the matching sequences is extracted (and put in the unique set), and used to recreate both versions. Similarly, the first (by timecode) unique image frame found defines the start of a sequence of unique image frames (a unique video segment), which continues until a matching image frame is found or the video data ends. In another example implementation, every unique image fingerprint may be collected per video and a delta of fingerprints created, highlighting the unique elements which may exist in each version. Once identified in this way, the process follows the first example, identifying contiguous sequences of fingerprints which exist in each version.

Image Hashes Fᵢ₁ are compared by computing a statistical similarity (or distance) metric, such as the Hamming distance d or the output of an XOR operation. The Hamming distance d is the number of digits in the compared fingerprints Fᵢ₁ that are different (i.e. d=0 means the fingerprints Fᵢ₁ are identical, d=1 means one digit is different, etc.). The same distance information (d) is provided by the number of Is in the output of the XOR operation. Two image frames do not need to have identical fingerprints (e.g. d=0) to be considered matching for the purposes of the method 100. In a preferred implementation, two image Hashes Fᵢ₁ are considered “matching” for the purposes of method 100 if their computed distance d is less than a threshold value, e.g. d<=2, to account for any differences in bitrates or compression of the different versions of video data 12 which may affect the fingerprints Fᵢ₁.

Colour histograms Fᵢ₂ are compared by determining the relative change in the colour bin values. In a preferred implementation, two image frames are considered “matching” on colour space if the corresponding colour bins for each image frame have values within a threshold percentage of the total pixel count of each other, e.g. 10%. This concept is demonstrated in tables 1-3 below.

TABLE 1
Exact match

| Frame A colour space Fᵢ₂ | Frame B colour space Fᵢ₂ |
|---|---|
| (r: 0, b: 0, g: 0) 50 | (r: 0, b: 0, g: 0) 50 |
| (r: 1, b: 0, g: 0) 0 | (r: 1, b: 0, g: 0) 0 |
| (r: 2, b: 0, g: 0) 10 | (r: 2, b: 0, g: 0) 10 |

TABLE 2
Close enough match (all colour bins
within 10% of total pixel count)

| Frame A colour space Fᵢ₂ | Frame B colour space Fᵢ₂ |
|---|---|
| (r: 0, b: 0, g: 0) 50 | (r: 0, b: 0, g: 0) 45 |
| (r: 1, b: 0, g: 0) 0 | (r: 1, b: 0, g: 0) 5 |
| (r: 2, b: 0, g: 0) 10 | (r: 2, b: 0, g: 0) 10 |

TABLE 3
No match (at least one colour bin is different
by >10% of total pixel count)

| Frame A colour space Fᵢ₂ | Frame B colour space Fᵢ₂ |
|---|---|
| (r: 0, b: 0, g: 0) 50 | (r: 0, b: 0, g: 0) 10 |
| (r: 1, b: 0, g: 0) 0 | (r: 1, b: 0, g: 0) 50 |
| (r: 2, b: 0, g: 0) 10 | (r: 2, b: 0, g: 0) 0 |

The secondary image fingerprint Fᵢ₂ can be used to check or validate the result of the primary fingerprint Fᵢ₁ comparison and reduce false positives. If two image frames being compared have identical or very similar image Hashes Fᵢ₁ (e.g., d<2) and the colour space comparison of the secondary fingerprint Fᵢ₂ also indicates a match, the two image frames are identified as matching. Whereas, if two image frames being compared have identical or very similar image Hashes Fᵢ₁ (e.g., d<2) but the colour space comparison of the secondary fingerprint Fᵢ₂ indicates no match, the two image frames are identified as not matching. A sequence of image frames that does not match with the corresponding image frames of any other version is identified as unique, i.e. a version-specific segment Vᵤ.

The fingerprint information Fᵢ comparison process results in the video data 12 of each version of the video asset 10a-10c being conceptually divided up into a series of video segments V[1]-V[n] containing either shared or version-specific content, with start and end timecodes defined by the start and end of the matching or unique sequences of image frames, similar to the examples in FIGS. 2-4(a). Once the shared video segments Vₛ and any version-specific video segments Vᵤ are identified in each version 12a-12c, the set Qᵥ of unique video segments Uᵥ needed for constructing the video data 12a-12c is determined by excluding duplicated ones/copies of the shared video segments Vₛ (since only one copy of each shared video segment Vₛ is required in the set Qᵥ). For example, in FIG. 2, any of segments Vₐ[1], V_{b}[1], and V_{c}[1] could be selected as the unique video segment Uᵥ in the set Qᵥ.

In the above frame-by-frame approach, the start and end timecodes delineating the video segments V[1]-V[n] are precisely determined based on the analysis of image fingerprint information Fᵢ. The length or time duration of each shared video segment Vₛ and each version-specific video segment Vᵤ is determined by the length of the respective matching and unique fingerprint sequences, which in turn is dependent on how the video data 12 has been varied between the different versions. However, in some embodiments, the length of each video segment V[1]-V[n] can be predefined, such that the video data 12 of each version can be divided into a series of equal length video chunks. For example, the length of each video segment V[1]-V[n] can be set in step 130v or adjusted later, or the video data 12 of each version received at step 110 can already be a series of video chunks which are then fingerprinted and compared in steps 120v-130v. The use of predefined video chunks is suitable for adaptive bitrate (ABR) applications discussed in more detail below with reference to step 170.

In step 140v, a composition Cy for each respective version is determined. The composition Cᵥ defines which unique video segments Uᵥ from the set Qᵥ need to be brought together and in what order to make up the video data 12 of each respective version. The composition Cᵥ comprises a list of references to one or more unique video segments Uᵥ from the set Qᵥ and information on the order or playback timeline of the video segments. In one example, the list references the unique video segments Uᵥ and a stored location of the set Qᵥ from which the unique video segments Uᵥ can be retrieved.

In step 150, the set Qᵥ of unique video segments Uᵥ are extracted from the original version masters 10a-10c and then stored along with the compositions Cᵥ for each version 10a-10c. The unique video segments Uᵥ are stored against a segment record/log which become the individual referenced items in the composition Cᵥ. Steps 120v-150 are fully automated.

Where the video assets 10a-10c also comprise audio data 14, the method 100 further comprises steps 120a-140a whereby an equivalent fingerprinting process is applied to the audio data 14a-14c to determine a set Qₐ of unique audio segments Uₐ and compositions Cₐ for constructing the audio data 14a-14c of each version 10a-10c, as described below.

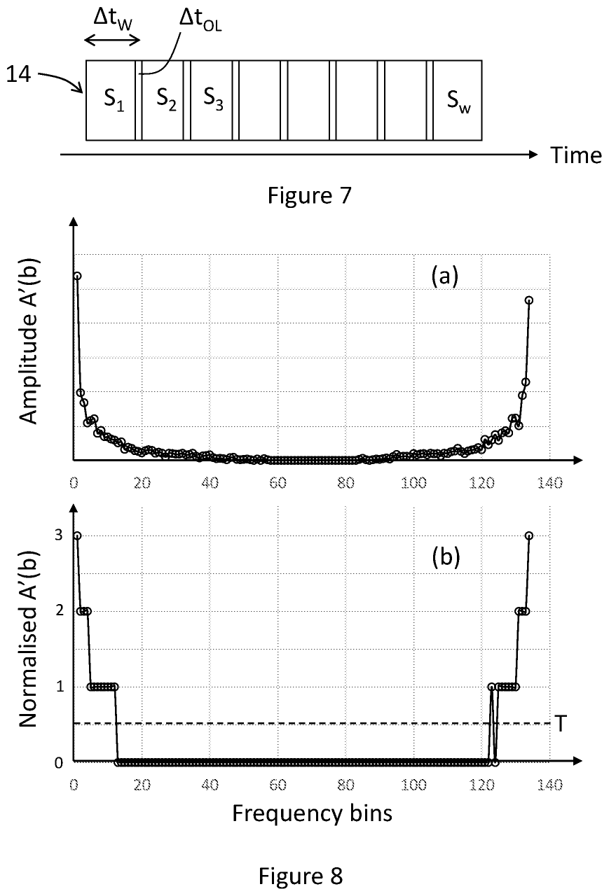

In step 120a, audio fingerprint information Fₐ is generated for each version 10a-10c. Like video data 12, audio data 14 is time series data, but instead of a series of image frames, audio data 14 contains an audio signal made up of a series of audio samples obtained over a period of time at a sample rate (e.g. 44 kHz). To analyse the content of audio data 14 over time, the audio data 14a-14c of each version of the video asset 10a-10c is partitioned or divided into a sequence of smaller overlapping audio slices or windows S₁-S_{w} of equal time duration Δt, as shown in FIG. 7. Each audio slice S₁-S_{w} is associated with a timecode indicating its time position in the sequence, e.g. the beginning, end or centre of the time window. The window duration Δt_{w} and overlap Δt_{OL} will depend on the specific audio, but Δt_{w} is typically in the range 20 to 200 ms and the overlap Δt_{OL} can be between 25 and 75%. Audio fingerprint information Fₐ is generated for each audio slice S₁-S_{w} based on its frequency content. Step 120a comprises calculating, for each audio slice S₁-S_{w}, its Fourier Transform (FT) to obtain an amplitude spectrum A(f) comprising a plurality of frequency components fᵢ each having a respective amplitude value Aᵢ, and deriving an audio fingerprint Fₐ₁ from the sequence of amplitude values Aᵢ in the amplitude spectrum A(f). Preferably, a window function is applied to the audio slices S₁-S_{w} to reduce spectral leakage, as is known in the art. The temporal overlap Δt_{OL} of the audio slices S₁-S_{w} helps to ensure all the samples in the audio data 14 are weighted roughly equally to avoid losing frequencies in the FT.

In an example implementation of the audio fingerprinting technique, the frequency components fᵢ are grouped together into a plurality of bins b, each bin having a bin amplitude value A′ aggregated from all the frequency components fᵢ included in that bin's range. The number of bins b determines the length of the resulting audio fingerprint Fₐ₁ (see below), which can be set dependent upon the specific application. Preferably, the frequency range of each bin b is not equal and is used to focus the fingerprint Fₐ₁ on regions of interest in the frequency spectrum A(f), such as human speech. FIG. 8(a) shows an example binned amplitude spectrum A′(b) for an audio slice. Because spectral amplitude is affected by the volume or loudness of the audio data in an audio slice S₁-S_{w}, preferably some form of loudness normalisation is performed. In one example, the binned amplitude spectrum A′(b) of each audio slice S₁-S_{w} is normalised by a reference value R₀ derived from either the maximum and/or root mean squared (RMS) amplitude value from the binned (A′(b)) or un-binned (A(f)) amplitude spectrum of the respective audio slice S₁-S_{w}, or from the maximum and/or RMS amplitude values from all the audio slices S₁-S_{w} in the audio data 12 of the particular version of the video asset 10. This can be performed before or after the frequency binning step. Alternatively or additionally, the Loudness Unit Full Scale (LUFS) level of each audio slice S₁-S_{w} can be measured and used to normalise the audio slices S₁-S_{w} in the time domain to have the same predefined perceived loudness, prior to calculating the FT. These normalising steps have the advantage of the resulting audio fingerprint Fₐ₁ being relatively volume agnostic. Normalisation is preferably followed by a step of rounding the normalised amplitude values to the nearest integer. FIG. 8(b) shows an example normalised binned amplitude spectrum A′(b) in which the values have been rounded to the nearest integer.

Once normalised, the sequence of normalised (and optionally rounded) amplitude values A′ (b) corresponding to the bins b is extracted, and converted into an audio fingerprint Fₐ₁ in the form of a bitstring. This can be achieved by applying a suitable threshold T (e.g. 1s for any values greater than T, and 0s for any values less than T). In the example of FIG. 8(b), the extracted sequence of normalised and rounded values is: [3, 2, 2, 2, 1, 1, 1, 1, 1, 1, 1, 1, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 1, 0, 1, 1, 1, 1, 1, 1, 2, 2, 2, 3], and the resulting binary fingerprint Fₐ₁ produced by applying the threshold T indicated by the horizontal dashed line is “111111111111000000000000000000000000000000000000000000000000000000000000000000000000000000 00000000000000000000000000000000101111111111”. The integer decimal number representation of this being 21772754570956921998164359647392044157951.

Similar to the image Hash Fᵢ₁ generated in step 120v, the process in step 120a described above generates an audio fingerprint Fₐ₁ that is relatively coarse/insensitive to small changes in the frequency component amplitudes, making it suitable for perceptual content comparison. If a more detailed comparison of audio content is required, the extracted sequence of normalised and rounded values can be used (without threshold) as a more granular audio fingerprint Fₐ₂ (see FIG. 8(b)).

In step 130a, a set Qₐ of unique audio segments Uₐ is identified from which the audio data 14a-14c of each version of the video asset 10 can be constructed. This involves comparing the audio fingerprint information Fₐ of each version to identify one or more shared audio segments Aₛ that are duplicated in two or more of the versions of audio data 14a-14c and any version-specific audio segments Aᵤ that are not duplicated across the versions of audio data 14a-14c. As with the video data 12, one of the versions of audio data 14 is selected as a base version, and the audio fingerprints Fₐ₁ of the other related versions are compared slice-by-slice to the audio fingerprints Fₐ₁ of the base version to identify matching sequences indicative of a shared audio segments Aₛ, and any unique sequences indicative of version-specific audio segments Aᵤ. Similar to the image Hashes Fᵢ₁, the audio fingerprints Fₐ₁ are compared by computing a statistical similarity/distance metric d, such as the Hamming distance d or the output of an XOR operation. Exact matches are not required. A degree of tolerance on the match is allowed to account for any differences in bitrate/resolution and compression between the versions. In one example implementation, two audio slices with d<2 are considered “matching” for the purposes of the method 100.

This process results in the audio data 14 of each version of the video asset 10a-10c being divided up into a series of audio segments A[m] containing either shared or version-specific content (not shown). Once the shared audio segments Aₛ and any version-specific audio segments Aᵤ are identified in each version of audio data 12a-12c, the set Qₐ of unique audio segments Uₐ for constructing the audio data 14a-14c of the different versions of the video asset 10a-10c is determined by excluding duplicated ones/copies of the shared audio segments Aₛ.

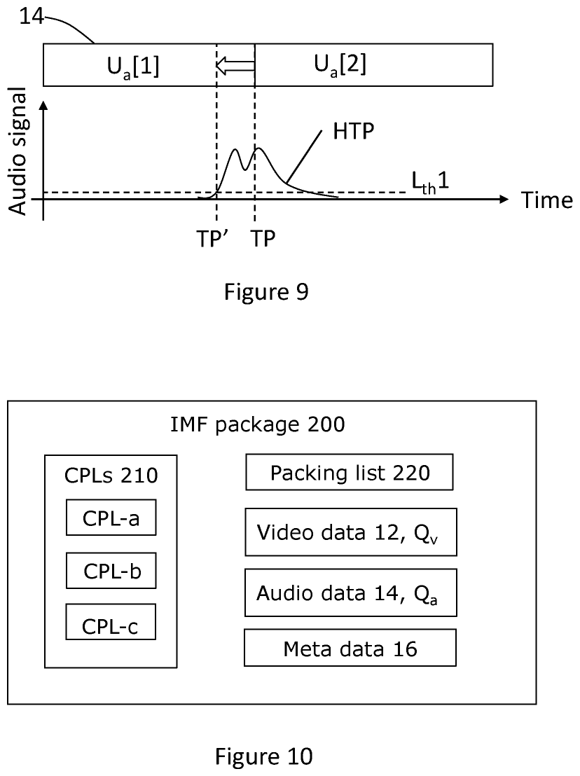

Optionally, in step 131a the seam positions TP between each unique audio segment Uₐ in a version are optimised/adjusted, as described below with reference to FIG. 9. Each unique audio segment Uₐ has a start timecode and end timecode. The end of one unique audio segment Uₐ [1] and the start of the next consecutive unique audio segment Uₐ[2] in a version defines a seam or transition point TP between the two consecutive unique audio segments Uₐ[1], Uₐ[2] in the version of the video asset 10 when constructed according to the respective composition Cₐ. If the transition point TP occurs during a period of human speech or other important audio (such as music), it could become distorted and/or result in artefacts such as stutters, pops or bangs etc., in the reconstructed version if the audio data 14 is split at that point TP. Such points of audio are referred to herein as “high transition” points HTP. Accordingly, in step 131a the transition points TP between the pairs of consecutive unique audio segments Uₐ[1], Uₐ[2] are optionally adjusted to avoid high transition points HTP and thereby optimise the seam positions, as illustrated in FIG. 9.

In an example implementation, step 131a comprises determining one or more sound levels L for each audio slice S₁-S_{w} in each pair of consecutive unique audio segments Uₐ[1], Uₐ[2], and adjusting the transition point TP to the timecode of the nearest audio slice in the pair of consecutive unique audio segments Uₐ[1], Uₐ[2] in which the one or more sound levels L are below one or more respective threshold levels Lth, or where no sound or speech/music is detected. The transition point TP can be adjusted forward or backward in time to a new position TP′, as indicated in FIG. 9. The amount of seam adjustment permitted is preferably restricted to a predefined (typically narrow) range about the original transition point TP, e.g. a percentage of the duration of the audio slice. In one example, the one or more sound levels L include an overall sound level L₁ for the audio slice, and one or more component sound levels L₂ for specific frequency components or bands of interest in the audio slice. The overall sound level L₁ is the LUFS, RMS or peak level extracted from the time domain audio signal. Component sound levels L₂ are determined from the amplitude spectrum A(f) of the respective audio slice, preferably after loudness normalisation as described above. The frequency components or bands of interest include, but not limited to, those areas associated with human speech and/or music. For example, during a conversation, the fundamental frequency of a typical adult man ranges from 80 to 180 Hz and that of a typical adult woman from 165 to 255 Hz. Singing extends these ranges as it is aimed at specific notes. Meanwhile, the full range of musical notes is from 16 to 7902 Hz. The component sound level(s) L₂ being below an associated threshold level Lₜₕ₂ indicates no speech and/or music being detected in the audio slice, while the overall sound level L₁ being below an associated threshold level Lₜₕ₁ indicates low volume or no sound in the audio slice, either of which may be an optimal transition point TP′.

In step 140a, a composition Cₐ for each respective version is determined. The composition Cₐ defines which of the one or more unique audio segments Uₐ from the set Qₐ need to be brought together and in what order to make up the audio data 12 of each respective version. The composition Cₐ comprises a list of references to one or more unique audio segments Uₐ from the set Qₐ and information on the order or playback timeline of the audio segments. In one example, the list references the unique video segments Uₐ and a stored location of the set Qₐ from which the unique audio segments Uₐ can be retrieved.

In step 150, the set Qₐ of unique audio segments Uₐ is extracted from the original version masters 10a-10c, which are then stored along with the compositions Cₐ. The unique audio segments Uₐ are stored against a segment record/log which become the individual referenced items in the composition Cₐ. Steps 120a-150 are fully automated.

The method 100 described above fully automates the process of detecting and removing duplicated video and audio content in multiple versions of a video asset 10a-10c, thereby providing an efficient and automated solution to managing multiple versions of a video asset 10 for reducing storage. The core process of identifying and extracting the sets Qᵥ, Qₐ of unique video and audio segments Uᵥ, Uₐ and compositions Cᵥ, Cₐ can be used for various purposes and to produce various different output formats irrespective of the format of the original version masters 10a-10c (e.g. IMF and ABR outputs are described further below).

The principles of the invention can also be used to detect the presence of multiple versions of the same video asset 10. For example, hundreds of video assets 10 could be received at step 110 containing an unknown number of versions 10a-10c of a particular video asset 10 which need to be detected before the unique video and audio segments Uᵥ, Uₐ can be identified in step 130v, 130a. In an embodiment, step 110 comprises receiving a plurality of video assets 10 including the multiple different versions 10a-10c of a video asset 10, and the method 100 further comprises detecting the multiple versions 10a-10c of the video asset 10 in the received plurality of video assets 10. Version detection can be performed at step 120.

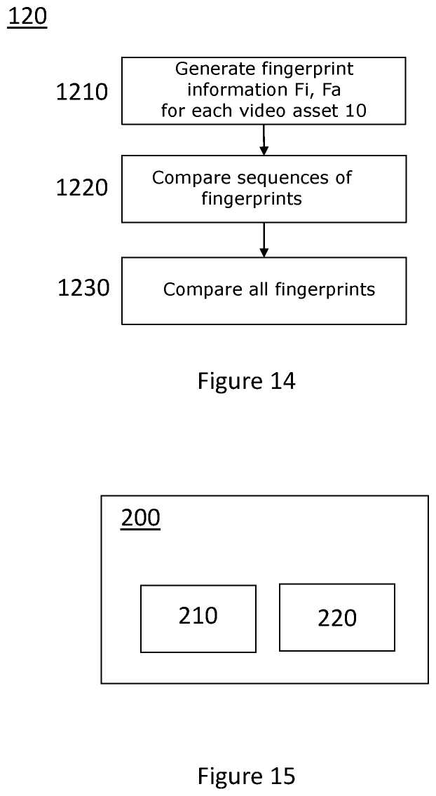

FIG. 14 shows an example method of detecting multiple versions 10a-10c of a video asset 10 in the received plurality of video assets 10 that can be implemented at step 120. Step 1210 comprises generating fingerprint information Fᵢ, Fₐ for each image frame and audio slice (where audio data 14 is present) as described previously in steps 120v and 120a. In step 1220, each video and audio fingerprint of each video asset 10 is paired with its respective timecode and compared to the fingerprint-timecode pairs of all the other received video assets 10 in the library to identify a shortlist of video assets 10 having a predefined amount or proportion of similar content. A similarity metric, such as the distance d, is calculated for each fingerprint-timecode pair of each video asset 10. That is, a similarity metric is computed for every pair of video/audio fingerprints at a given timecode. In this initial filtering stage, video assets 10 having a minimum percentage (e.g. at 75%) of their video or audio fingerprint-timecode pairs within a first threshold distance dₜₕ₁ (e.g. d<50) of each other are filtered out/selected as possible versions and shortlisted for further analysis. In step 1230, all the fingerprint information Fᵢ, Fₐ of the possible versions are compared frame-by-frame (or slice by slice) by timecode. If a certain number or proportion of the fingerprints Fᵢ, Fₐ in one of the possible video assets 10 are within a second threshold distance dₜₕ₂ of the fingerprints Fᵢ, Fₐ of another of the possible versions, where dₜₕ₂<dₜₕ₁, those two possible versions are identified as versions 10a, 10b of the same video asset 10. If all the fingerprints Fᵢ, Fₐ in one of the possible video assets 10 are within a third threshold distance dₜₕ₃ of the fingerprints Fᵢ, Fₐ of another of the possible versions, where dₜₕ₃<dₜₕ₂<dₜₕ₁, that possible version is identified as a duplicate version and can be removed from the shortlist and/or deleted. Once the versions 10a-10c of the video asset 10 are detected, the method 100 proceeds to step 130v, 130a to identify the sets Qᵥ, Qₐ of unique video and audio segments Uᵥ, Uₐ, as described above.

In an embodiment, once the sets Qᵥ, Qₐ of unique video and audio segments Uᵥ, Uₐ have been prepared as described above in steps 120v, 120a to 150, the method 100 proceeds to step 160 in which an IMF output is generated. With reference to FIG. 10, as is known in the art, an IMF package 200 contains all the video 12 and audio data 14 and metadata 16 required to create the versions 10a-10c, a composition playlist (CPL) 210 for each version 10a-10c specifying how to construct the required version, and a manifest or packing list 220 specifying all the data contained in the IMF package 200. Generating the IMF package 200 involves creating the IMF folder or directory structure 200 and adding the unique video and audio segments Uᵥ, Uₐ and any metadata 16 to it. The packing list 220 and the CPLs 210 are also created and saved to the IMF package 200. CPLs 210 are created based on the compositions Cᵥ, Cᵤ. Once the IMF package 200 is created, any version of the video asset 10a-10c can be created by executing the respective CPL-a, CPL-b, CPL-c, as is known in the art. The method 100 therefore fully automates the generation of IMF packages from traditional versions.

Step 160 can also include a self-validation step in which the video data 12 and audio data 14 of the versions 10a-10c created from the automatically generated IMF package 200 are compared directly to that of the original version masters 10a-10c to check for consistency or errors. This involves executing the CPLs 210 to create the versions 10a-10c from the IMF package 200 (referred to herein as IMF versions 10a^{IMF}-10c^{IMF}). Each IMF version is constructed from an aggregation of unique video and audio segments Uᵥ, Uₐ according to the composition in the respective CPL 210. Steps 120v and 120a are then repeated to generate image fingerprint information Fᵢ^{IMF} and audio fingerprint information Fₐ^{IMF} for each IMF version 10a^{IMF}-10c^{IMF}. The fingerprint information Fᵢ, Fₐ from the original version masters 10a-10c is already generated. The video and audio fingerprint sequences of the IMF versions 10a^{IMF}-10c^{IMF} are then compared directly by timecode to the fingerprint sequences of the original versions 10a-10c using the techniques described above to detect any differences, thus forming a quality control step for the IMF package 200. Any differences detected can be flagged for further investigation.

It will be appreciated that IMF is a strict format which includes a set codec and other requirements. However, the invention is not limited to this format. Alternative packages that use different formats and codecs can be created based on the identified sets Qᵥ, Qₐ of unique video and audio segments Uᵥ, Uₐ and compositions Cᵥ, Cₐ.

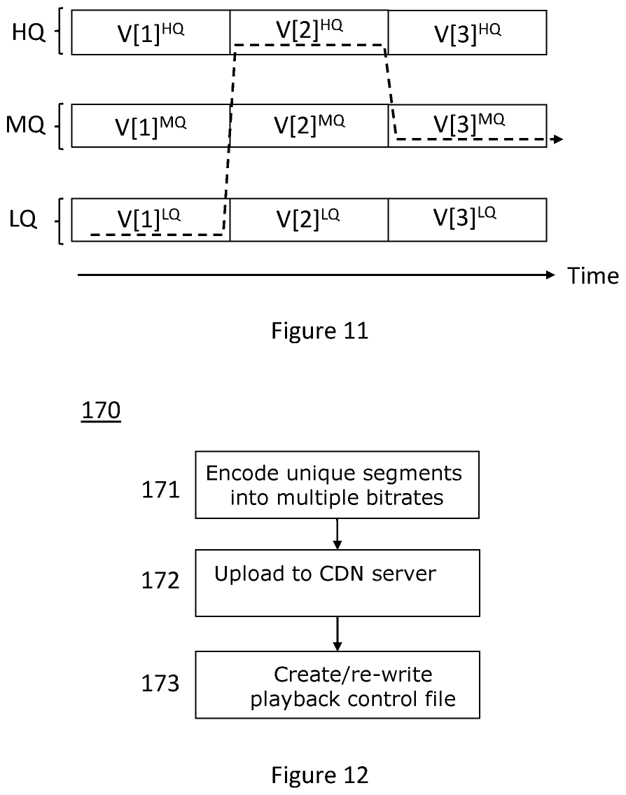

The method 100 can also be used to reduce the volume of content stored in content delivery networks (CDNs) for adaptive bitrate (ABR) streaming of content. In this case, once the sets Qᵥ, Qₐ of unique video and audio segments Uᵥ, Uₐ have been prepared as described above in steps 120v, 120a to 150, the method 100 proceeds to step 170 in which an adaptive bitrate (ABR) output is generated. ABR technology uses short 2-10s chunks of video and audio content made available at multiple different bitrates to stream a video asset 10 rather than downloading it in one go. Current ABR standard protocols HLS (HTTP live streaming) and DASH (dynamic adaptive streaming over HTTP) use playback control files, known as playlists and manifests, that are sent to the client video player to tell it which chunks can be played next and which bitrates are available. The video player then decides which bitrate chunks to use based on the network conditions, i.e. good bandwidth allows higher bitrate chunks to be used. This is shown schematically in FIG. 11 for three consecutive chunks of video content encoded at three different bitrates: low quality LQ (low bitrate) chunks V[1]^{LQ}-V[3]^{LQ}, medium quality MQ (medium bitrate) chunks V[1]^{MQ}-V[3]^{MQ}, and high quality HQ (high bitrate) chunks V[1]^{HQ}-V[3]^{HQ} The dashed arrow indicated the dynamic selection of different bitrate chunks used as the network conditions change. Currently, CDNs store each chunk of each version 10a-10c in full at each bitrate.

FIG. 12 shows the process in step 170 in more detail. In step 171, the extracted sets Qᵥ, Qₐ of unique video and audio segments Uᵥ, Uₐ are encoded into multiple bitrates. In step 172, the sets Qᵥ, Qₐ of unique video and audio segments Uᵥ, Uₐ at each bitrate are uploaded to a CDN server together with version information about the available bitrates and the composition Cᵥ, Cₐ of unique video and audio segments Uᵥ, Uₐ for each version 10a-10c.

The unique video and audio segments Uᵥ, Uₐ uploaded to the CDN should be video/audio chunks of a predefined size/duration, as required by the relevant ABR protocol. This can be achieved in a number of ways. In one implementation, with reference to step 130v, 130a, rather than letting the length of the identified video/audio segments be freely determined by the length of the matching and unique fingerprint sequences, the length of each video/audio segment is set to be a chunk of a predefined size/duration, or an integer number of chunks of a predefined size (e.g. multiples of 5s). In this way, the length of the unique video and audio segments Uᵥ, Uₐ is quantised into chunks of a predefined size. Then, step 171 may further comprise splitting/dividing any unique video and audio segments Uᵥ, Uₐ consisting of multiple chunks into individual chunks prior to, or after, encoding them into the multiple bitrates. In another implementation, in step 130v, 130a, the length of each segment is set to be an individual chunk of a predefined size. As such, the video data 12 and audio data 14 is conceptually divided into a sequence of chunks, and the fingerprints Fᵢ, Fₐ of each chunk in each version 10a-10c are compared by timecode to identify shared video chunks Vₛ and audio chunks Aₛ and any version-specific video chunks Vᵤ and audio chunks Aᵤ. In this way, the unique video and audio segments Uᵥ, Uₐ at step 171 are already chunks of predefined size suitable for ABR streaming. In yet another implementation, step 171 can comprise adjusting the size of the unique video and audio segments Uᵥ, Uₐ to correspond to an integer number of chunks of a predefined size, and dividing/splitting any adjusted unique video and audio segments consisting of multiple chunks into individual chunks prior to or after encoding into the multiple bitrates.

In step 173, the playback control file for each version is created or re-written based on the version information to point to (e.g. using URLs) the unique segments (now chunks) Uᵥ, Uₐ for each version 10a-10c stored in the CDN.

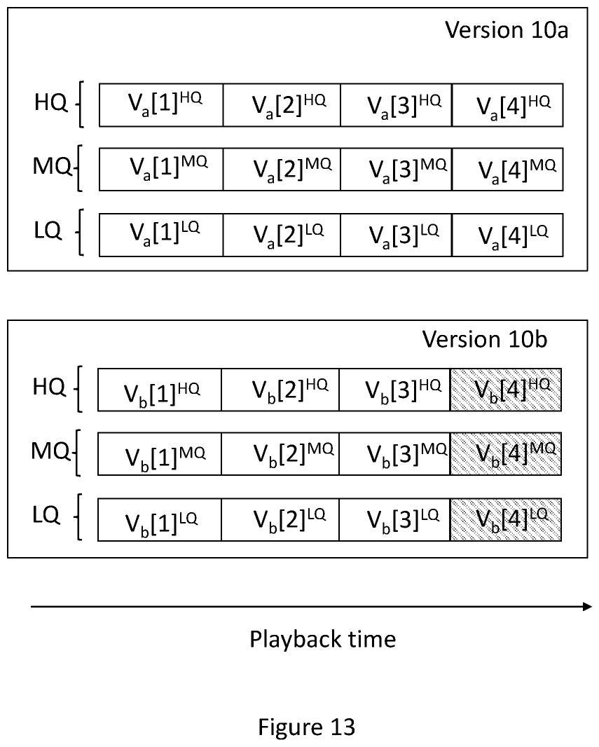

This is illustrated schematically in FIG. 13 in which the video content of two versions 10a and 10b comprises four video chunks Vₐ[1]-Vₐ[4] and V_{b}[1]-V_{b}[4] respectively which differ only in the last chunks Vₐ[4] and V_{b}[4]. The unique set Qᵥ of video chunks (segments) is {Vₐ[1], Vₐ[2], Vₐ[3], Vₐ[4] and V_{b}[4]} which are encoded in multiple bitrates (HQ, MQ and LQ) and uploaded to the CDN. The playback control file (e.g. DASH manifest or HLS playlist) is written so that the video player retrieves unique video chunks Vₐ[1]-Vₐ[4] (at a given bitrate) when streaming version 10a and retrieves unique video chunks Vₐ[1]-Vₐ[3], and V_{b}[4] (at a given bitrate) when streaming version 10b. Thus, chunks Vₐ[1]-Vₐ[3], which are common across the two versions 10a, 10b are only stored/hosted once at each bitrate rather than twice, and are only propagated around the world in the CDN once rather than twice. In realistic scenarios where there are tens or hundreds of versions of a video asset 10 available for ABR streaming, the method 100 results in significant reduction in storage space and associated cost and carbon footprint.

If, at a later date, a new version 10d of the video asset 10 is created or received, the video data 12 and audio data 14 of the new version 10d is fingerprinted using the same process described in step 120v, 120a, and steps 130v, 130a-150 are repeated for the new set of versions 10a-10d. The result of this process is an updated set Qᵥ′ of unique video segments Uᵥ′ and/or an updated set Qₐ′ of unique audio segments Uₐ′ (depending on how the new version 10d differs from the other versions 10a-10c), and updated compositions Cᵥ′, Cₐ′ of unique video and audio segments Uᵥ′, Uₐ′ from the updated sets Qᵥ′, Qₐ′.

It will be appreciated that, depending on how the new version 10d differs from the other versions 10a-10c, the updated sets Qᵥ′, Qₐ′ may be identical to the original sets Qᵥ, Qₐ, or they may be different. For example, with reference to FIG. 3, it can be seen that the video data 12d of version 10d can be constructed from the unique video segments Uᵥ identified from versions 10a-10c, in which case there would be no change to the set Qᵥ if version 10d were added at a later date. On the other hand, the updated sets Qᵥ′, Qₐ′ will be different to the original sets Qᵥ, Qₐ if the new version 10d contains any version-specific video segments Vᵤ and/or any version-specific audio segments Aᵤ. This will result in the sets Qᵥ′, Qₐ′ containing one or more new unique video and/or audio segments Uᵥ′, Uₐ′. Further, the updated sets Qᵥ′, Qₐ′ may or may not include all the unique segments Uᵥ, Uₐ from the original sets Qᵥ, Qₐ. For example, with reference to FIG. 4(a), if version 10c were the newly added version, the updated set Qᵥ′ would contain all the unique video segments Uᵥ in the original set Qᵥ plus the new unique video segment V_{c}[3]. In this scenario, the updated compositions Cᵥ′ of the other versions 10a, 10b would be identical to the original compositions Cᵥ. If, however, the video data 12c of the new version 10c instead or additionally included a video segment located somewhere between t0 and t1 with new content as indicated by segment V_{c}[X] spanning t01 to t02 in FIG. 4(b), then the updated set Qᵥ′ would not contain all the unique video segments Uᵥ in the original set Qᵥ. This is because the unique video segment Vₐ[1] (=Vₐ[2]) in the original set Qᵥ would be replaced by/split into three new unique video segments Vₐ[4], Vₐ[5], Vₐ[6] (where Vₐ[1]=Vₐ[4]+Vₐ[5]+Vₐ[6]) during step 130v. In this scenario, the updated compositions Cᵥ′ of the other versions 10a, 10b would be different to the original compositions Cy because they reference a different combination of unique video segments Uᵥ′.

In the case of the IMF output 160, the IMF package 200 can be updated to include any new unique video and/or audio segments Uᵥ′, Uₐ′ along with a CPL 210 for the new version 10d. The CPLs 210 of the other versions 10a-10c can be updated as needed based on the updated compositions Cᵥ′ (see above). In the case of the ABR output 170, any new unique video and/or audio segments Uᵥ′, Uₐ′ (in the form of chunks) associated with the new version 10d are encoded into multiple bitrates and uploaded to the CDN along with a new playback control file for the new version 10d which reuses the existing the chunks already stored in the CDN. In particular, where the new version 10d is the result of an amendment to an old version, this approach means that there is no duplication of content during the transition period before the old/original version is deleted from the CDN.

FIG. 15 shows a schematic diagram of a system for implementing the above-described method 100. The system comprises one or more processing devices 210 configured with instructions that, when executed by the one or more processing devices 210, cause the one or more processing devices to perform the method 100. The system may comprise a computer-readable medium in communication with the one or more processing devices 210 storing the instructions.

Accordingly, aspects of the present disclosure may be implemented entirely hardware, entirely software (including firmware, resident software, micro-code, etc.) or combining software and hardware implementation that may all generally be referred to herein as a “unit,” “module,” or “system”. Furthermore, aspects of the present disclosure may take the form of a computer program product embodied in one or more computer-readable media having instructions or computer readable program code embodied thereon. Program code embodied on a computer readable signal medium may be transmitted using any appropriate medium, including wireless, wireline, optical fibre cable, RF, or the like, or any suitable combination of the foregoing.

The computer readable medium 220 may include a mass storage, a removable storage, a volatile read-and-write memory, a read-only memory (ROM), or the like, or any combination thereof. Exemplary mass storage may include a magnetic disk, an optical disk, a solid-state drive, etc.

Computer program code or instructions for carrying out disclosed methods may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on a user's computer, as a stand-alone software package, partly on a user's computer and partly on a remote computer or entirely on a remote computer or server. In the latter scenario, the remote computer may be connected to a user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

From reading the present disclosure, other variations and modifications will be apparent to the skilled person. Such variations and modifications may involve equivalent and other features which are already known in the art, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

1. A computer-implemented method of managing multiple different versions of a video asset, each version of the video asset comprising video data including a sequence of image frames, the method comprising:
automatically identifying a set of one or more unique video segments from which the video data of each version of the video asset can be constructed, by:
generating, for each version of the video asset, image fingerprint information for each image frame based on its content; and
comparing the image fingerprint information of each version to identify one or more shared video segments that are used in at least two of the versions, and any version-specific video segments; and
determining, for each version of the video asset, a composition of one or more unique video segments from the set that makes up the video data of the respective version.

2. The method of claim 1, wherein comparing the image fingerprint information of each version comprises:
selecting one of the versions as a base version; and
comparing the image fingerprint information of the base version to the fingerprint information of each other version frame-by-frame to identify one or more sequences of matching image frames indicative of one or more shared video segments, and to identify any sequences of unique image frames that are indicative of version-specific video segments.

3. The method of claim 2, wherein comparing the image fingerprint information of a given pair of image frames comprises:
computing one or more similarity or distance metrics from the image fingerprint information of the pair of image frames; and
identifying the pair of image frames as matching if the one or more similarity or distance metrics satisfy one or more respective matching conditions.

4. The method of claim 3, wherein the image fingerprint information comprises a primary image fingerprint generated using a first image fingerprinting technique and a secondary image fingerprint generated using a second fingerprinting technique; and comparing the image fingerprint information of a given pair of image frames comprises:
computing a first distance or similarity metric for the primary image fingerprints of the pair of image frames;
computing a second distance or similarity metric from the secondary image fingerprints of the pair of image frames; and
identifying the pair of image frames as matching if both the primary and secondary fingerprints satisfy a respective matching condition; and, preferably,
wherein the primary fingerprint is generated using a perceptual Hash function, and the secondary fingerprint is generated from pixel colour information in the image frame; and, preferably,
wherein the secondary image fingerprint comprises a colour histogram with a plurality of colour bins, and the second distance or similarity metric comprises a relative change in each colour bin value of the colour histograms.

5. (canceled)

6. The method of claim 1, wherein the multiple versions of the video assets further comprise audio data, and the method further comprises:
identifying a set of one or more unique audio segments from which the audio data of each version of the video asset can be constructed, by:
partitioning the audio data of each version into a sequence of audio slices of equal time duration;
generating, for each version, an audio fingerprint for each audio slice based on its content; and
comparing the audio fingerprints of each version to identify one or more shared audio segments that are used in two or more of the versions and any version-specific audio segments; and
determining, for each version of the video asset, a composition of one or more unique audio segments from the set that makes up the audio data of the respective version; and, preferably,
wherein generating the audio fingerprint for each audio slice comprises:
transforming the audio slice from the time domain to the frequency domain to obtain an amplitude spectrum having a plurality of frequency components, each frequency component having a respective amplitude value;
grouping the frequency components into a predefined number of bins, wherein each bin has an aggregated amplitude value;
determining an audio fingerprint based on the sequence of aggregated amplitude values associated with the bins; and
normalising the audio data in each audio slice of the version to have the same perceived loudness before transforming the audio slice to the frequency domain; and, further preferably,
wherein determining the audio fingerprint based on the sequence of aggregated amplitude values comprises:
transforming the sequence of aggregated amplitude values into a sequence of bits; and, preferably, wherein transforming the sequence of aggregated amplitude values into a sequence of bits comprises, normalising the sequence of aggregated amplitude values, and applying a threshold.

7-8. (canceled)

9. The method of claim 6, wherein each unique audio segment has a start and an end timecode, wherein the end of one unique audio segment and the start of the next consecutive unique audio segment in a version defines a transition point between the two consecutive unique audio segments in the version when constructed according to the respective composition, the method further comprising:
adjusting the transition point between two consecutive unique audio segments to avoid one or more of the following: sound above a predefined level, music and human speech at the transition point, based on the audio content at or near the transition point; and, preferably
wherein adjusting the transition point between the two consecutive unique audio segments comprises:
detecting the presence or absence of human speech and/or music in each audio slice of the consecutive unique audio segments based on the frequency content of the respective audio slice; and
adjusting the transition point to the timecode of the nearest audio slice in which human speech and/or music is not detected.

10. (canceled)

11. The method of claim 9, wherein adjusting the transition point between the two consecutive unique audio segments comprises:
determining at least one sound level for each audio slice of the consecutive unique audio segments; and
where the at least one sound level at the transition point is greater than a respective threshold value, adjusting the transition point to the timecode of the nearest audio slice in which the at least one sound level is less than the respective threshold value; and, preferably,
wherein the at least one sound level comprises an overall sound level of the audio slice, optionally or preferably, a Loudness Unit Full Scale (LUFS) level; and/or
wherein the at least one sound level comprises one or more component sound levels for specific frequency components or bands of interest extracted from the amplitude spectrum of the audio slice, preferably, wherein the specific frequency components or bands of interest are associated with human speech and/or music.

12. (canceled)

13. The method of claim 1, further comprising:
extracting the identified set of unique video segments from the video data of the multiple versions of the video asset; and
storing the extracted set of unique video segments together with version information containing the composition for each version.

14. The method of claim 13, wherein the multiple versions of the video assets further comprise audio data, the method further comprising:
extracting the identified set of unique audio segments from the audio data of the multiple versions of the video asset; and
storing the extracted set of unique audio segments together with version information containing the composition for each version; and, preferably,
generating an interoperable master format (IMF) package for the multiple versions of the video asset based on the extracted sets of unique video and audio segments and the compositions of each version; and further preferably validating the generated IMF package by:
generating each of the multiple versions from the IMF package, each generated version comprising generated video and audio data comprising an aggregation of respective unique video and audio segments from the sets;
generating, for the generated video data of each generated version of the video asset, image fingerprint information for each image frame based on its content;
partitioning the generated audio data of each generated version into a sequence of audio slices of equal time duration, and generating audio fingerprint information for each audio slice of each generated version based on its content; and
comparing, by timecode, the image and audio fingerprint information of each generated version to the image and audio fingerprint information of each respective version master used to generate the IMF package, to determine whether they match or not;
wherein the IMF package is determined to be valid if the generated image and audio data of the generated versions match the video and audio data of the respective version masters used to generate the IMF package.

15-16. (canceled)

17. The method of claim 1, further comprising:
encoding the set of unique video segments into multiple bitrates; and
storing the set of unique video segments at each bitrate together with version information containing the available bitrates and the composition of unique video segments for each version.

18. The method of claim 17, wherein the step of storing comprises:
uploading the set of unique video segments at each bitrate and the version information to one or more servers for use in adaptive bitrate streaming; and, preferably,
generating or amending, for each version, a playback control file for the adaptive bitrate streaming protocol based on the version information so as to reference the unique video segments at each bitrate stored in the one or more servers, optionally wherein the references comprise URLs for retrieving the unique video segments during playback of the video asset; and
uploading the generated or amended playback control files to the one or more servers for use in adaptive bitrate streaming.

19. (canceled)

20. The method of claim 1, further comprising:
receiving a new version of the video asset, the new version of the video asset comprising video data including a sequence of image frames;
generating, for the new version, image fingerprint information for each image frame based on its content;
identifying an updated set of unique video segments from which the video data of all versions of the video asset can be constructed by:
comparing the image fingerprint information of each version to identify one or more shared video segments that are used in at least two of the versions, and any version-specific video segments; and
determining, for each version of the video asset, an updated composition of one or more unique video segments from the updated set that makes up the video data of the respective version.

21. The method of claim 20, wherein the multiple versions of the video assets further comprise audio data, and the method further comprises:
identifying a set of one or more unique audio segments from which the audio data of each version of the video asset can be constructed, by:
partitioning the audio data of each version into a sequence of audio slices of equal time duration;
generating, for each version, an audio fingerprint for each audio slice based on its content; and
comparing the audio fingerprints of each version to identify one or more shared audio segments that are used in two or more of the versions and any version-specific audio segments; and
determining, for each version of the video asset, a composition of one or more unique audio segments from the set that makes up the audio data of the respective version,
wherein the new version of the video asset further comprises audio data, and the method further comprises:
partitioning the audio data of the new version into a sequence of audio slices of equal time duration, and generating audio fingerprint information for each audio slice based on its content; and
identifying an updated set of one or more unique audio segments from which the audio data of all the versions of the video asset can be constructed by:
comparing the audio fingerprint information of each version to identify one or more shared audio segments that are used in two or more of the versions and any version-specific audio segments; and
determining, for each version of the video asset, an updated composition of one or more unique audio segments from the updated set that makes up the audio data of the respective version.

22. The method of claim 20, further comprising:
extracting the identified updated set of unique video segments from the video data of the versions of the video asset; and
storing the updated set of unique video segments together with version information containing the updated composition for each version.

23. The method of claim 22, further comprising:
extracting the identified updated set of unique audio segments from the audio data of the versions of the video asset; and
storing the extracted updated set of unique audio segments together with version information containing the updated composition for each version; and, preferably,
extracting the identified set of unique audio segments from the audio data of the multiple versions of the video asset;
storing the extracted set of unique audio segments together with version information containing the composition for each version;
generating an interoperable master format (IMF) package for the multiple versions of the video asset based on the extracted sets of unique video and audio segments and the compositions of each version; and
updating the IMF package for the multiple versions of the video asset based on the updated set of unique video and audio segments and the updated compositions of each version and

24. (canceled)

25. The method of claim 20, further comprising:
encoding the set of unique video segments into multiple bitrates;
storing the set of unique video segments at each bitrate together with version information containing the available bitrates and the composition of unique video segments for each version; and
where the updated set comprises one or more new unique video segments that were not present in the previous set:
encoding the one or more new version-specific video segments into the multiple bitrates; and
updating the stored sets to include the one or more new unique video segments at each bitrate and the version information for the new version; and, preferably,
wherein updating the stored sets comprises:
uploading the one or more new unique video segments at each bitrate to the one or more servers together with the updated version information for the new version;
generating or amending a playback control file for the new version based on the version information so as to reference the unique video segments at each bitrate stored in the one or more servers, optionally wherein references comprise URLs for retrieving the unique video segments during playback; and
uploading the generated or amended playback control file to the one or more servers for use in adaptive bitrate streaming.

26. (canceled)

27. The method of claim 1, wherein:
(i) each identified unique video segment in the set is a video chunk of a predefined duration; or
(ii) each identified unique video segment in the set is an integer number of video chunks of a predefined duration; or
(iii) wherein each unique video segment has a start and an end timecode, wherein the end of one unique video segment and the start of the next consecutive unique video segment in a version defines a transition point between the two consecutive unique video segments in the version when constructed according to the respective composition, the method further comprising:
adjusting the transition points between consecutive unique video segments such that each identified unique video segment in the set corresponds to an integer number of video chunks of a predefined duration; and, preferably,
wherein the predefined duration of the video chunks is defined by an adaptive bitrate protocol; and/or wherein parts (ii) or (iii) further comprise dividing any unique video segments corresponding to multiple video chunks into individual video chunks.

28. (canceled)

29. The method of claim 1 further comprising:
receiving a plurality of video assets including the multiple versions of the video asset, each video asset comprising video data;
generating, for each video asset received, image fingerprint information for each image frame based on its contents;
where the video assets comprise audio data, partitioning the audio data of each video asset into a sequence of audio slices of equal time duration, and generating, for each video asset, an audio fingerprint for each audio slice based on its content; and
detecting the multiple versions of the video asset in the plurality of video assets based on a comparison of the image fingerprint information, and where present the audio fingerprint information, of each video asset; and, preferably,
wherein the image fingerprint information for each image frame, and where present the audio fingerprint for each audio slice, is associated with a respective timecode, and detecting the multiple versions comprises:
identifying a subset of candidate video assets having a predefined proportion of identical or similar image fingerprint-timecode pairs, and where present audio fingerprint-timecode pairs;
comparing the image fingerprint information of the identified candidate video assets frame-by-frame and by timecode, and where present the audio fingerprint information of the identified candidate video assets slice-by-slice and by timecode; and
identifying those candidate video assets having a predefined proportion of matching video and/or audio content as multiple versions of a video asset; and preferably, identifying those candidate video assets with identical or fully matching video content, and where present identical or fully matching audio content, as duplicate versions; and, further preferably,
computing, for each pair of compared image frames, and where present each compared pair of audio slices, one or more distance metrics from the respective image and audio fingerprint information; and
wherein identifying candidate video assets with a predefined proportion of identical or similar fingerprint-timecode pairs comprises:
comparing the one or more distance metrics to one or more respective first threshold values; and
wherein identifying those candidate video assets having a predefined proportion of matching video and/or audio content comprises comparing the one or more distance metrics to one or more respective second threshold values, where the one or more second threshold values are lower than the one or more first threshold values.

30-32. (canceled)

33. A system for managing multiple different versions of a video asset, comprising one or more processing devices configured with instructions that, when executed by the one or more processing devices, cause the one or more processing devices to perform the method as defined in claim 29.

34. A computer-readable medium storing instructions that, when executed by one or more processing devices, cause the one or more processing devices to perform the method as defined in claim 1.
